(19) United States
(12) Patent Application Publication
(10) Pub. No.: US 2020/0118243 A1
(43) Pub. Date: Apr. 16, 2020

(54) DISPLAY METHOD, DISPLAY DEVICE, AND COMPUTER-READABLE RECORDING MEDIUM

(71) Applicant: Panasonic Intellectual Property Corporation of America, Torrance, CA (US)

(72) Inventors: Yusaku OTA, Osaka (JP); Kohei TAHARA, Osaka (JP); Yuji KUNITAKE, Osaka (JP); Atsushi IKENO, Kyoto (JP); Hiroko SUGIMOTO, Kyoto (JP)

(21) Appl. No.: 16/591,840

(22) Filed: Oct. 3, 2019

(30) Foreign Application Priority Data
Oct. 11, 2018 (JP) 2018-192622

(51) Int. Cl. G06T 3/40; G06F 16/38; G06F 3/041

(52) U.S. Cl. CPC G06T 3/40; G06F 3/0412; G06F 3/0416; G06F 16/38

(57) ABSTRACT

A processor, when a distance indicated by a distance information is greater than or equal to a first reference distance, displays, in a display, a second number of first objects each corresponding to each or a plurality of a first number of apparatuses and indicative of a state of the corresponding apparatus, and when a distance indicated by the distance information is less than the first reference distance, selects a third number of apparatuses from among the first number of apparatuses according to a predetermined condition, the third number being smaller than the first number, to display, in the display, a fourth number of second objects each corresponding to each or a plurality of the third number of apparatuses and indicative of a state of the corresponding apparatus.

### FIELD OF THE INVENTION

The present disclosure relates to a technique for displaying a state of an apparatus installed in a building.

### BACKGROUND ART

Household electrical appliance network systems are known in which a current state of a household electrical appliances can be displayed (e.g., see JP 2008-46934 A). Specifically, J P 2008-46934 A discloses a technique related to a household electrical appliance network system in which state change information is obtained from each household electrical appliance to store history information of each household electrical appliance, an icon of each household electrical appliance is displayed on a top screen, and when a certain icon is selected, history information of a household electrical appliance corresponding to the selected icon is displayed, the technique being for, when there is a household electrical appliance having history information yet to be read, additionally displaying information that the history information is yet to be read on an icon of the household electrical appliance displayed on the top screen.

On the other hand, as a technique for changing display contents and a granularity on a display screen according to a distance between a user and a display screen, the techniques are known which are disclosed in JP 2013-146375 A, JP 2010-4118 A, JP 5423183 B2, and JP 2003-280803 A.

Specifically, J P 2013-146375 A discloses a game machine, intended to provide presentation reflecting a mental state of a player such as a player's interest in presentation, in which a house appearance image is displayed when a position of a player's face relative to a game board is at a reference position, and when the player's face relative to the game board comes closer than the reference position, a door of the house is opened, and then a presentation image is switched to a scene in the house (paragraph [0194], FIGS. 35(a) to 35(c)).

JP 2010-4118 A discloses a digital photo frame in which when a distance between a user and a display section is equal to or greater than a predetermined distance, for example, a simple image (normal image) is displayed as a weather forecast image, and when the distance is smaller than the predetermined distance, a detailed image is displayed for informing detailed weather forecast using small letters or the like as a weather forecast image (paragraph [0094], FIGS. 3(A) and 3(B)).

Japanese Patent No 5423183 B2 discloses a display control device in which when a viewer is away from a display screen, the content being viewed by the viewer is arranged at the center on the display screen, and as the viewer approaches the display screen, the number of thumbnail images displaying the contents is increased to be displayed such as three, nine, and 15 thumbnails (paragraph [0054], FIG. 3(A)).

JP 2003-280803 A discloses an information processor in which when a pen is brought closer to an input unit, an icon button for function selection or an icon button for transition to another application program is displayed, and when the pen is moved away from the input unit, no icon button is displayed (paragraph [0032]).

However, the above conventional techniques need further improvement because it is not possible to display a state of an apparatus so as to ensure bird's-eye view properties and minuteness without imposing burdensome operation on a user.

### SUMMARY OF THE INVENTION

An object of the present disclosure is to provide a technique which enables display of a state of an apparatus so as to ensure bird's-eye view properties and minuteness without imposing burdensome operation on a user.

A display method according to one aspect of the present disclosure is a display method in a display device installed in a building, the display method including, by a processor of the display device, obtaining distance information acquired using a sensor, the distance information being indicative of a distance between the display device and a user; obtaining a state of a first number of apparatuses installed in the building by using a communication device; when a distance indicated by the distance information is greater than or equal to a first reference distance, displaying, in a display, a second number of first objects each corresponding to each or a plurality of the first number of apparatuses and indicative of a state of the corresponding apparatus; and when a distance indicated by the distance information is less than the first reference distance, selecting, a third number of apparatuses from among the first number of apparatuses according to a predetermined condition, the third number being smaller than the first number, to display, in the display, a fourth number of second objects each corresponding to each or a plurality of the third number of apparatuses and indicative of a state of the corresponding apparatus.

The present disclosure enables display of a state of an apparatus so as to ensure bird's-eye view properties and minuteness without imposing burdensome operation on a user.

### BRIEF DESCRIPTION OF THE DRAWINGS

FIG. 1 is a block diagram showing a configuration of a display system including a display device according to a first embodiment of the present disclosure;

FIG. 2 is a diagram showing one example of a configuration of apparatus information and state information;

FIG. 3 is a diagram showing a configuration of a second template image;

FIG. 4 is a diagram showing a configuration of a second content;

FIG. 5 is a diagram showing a configuration of a first template image;

FIG. 6 is a diagram showing a configuration of a first content;

FIG. 7 is a flow chart showing operation of the display device according to the first embodiment of the present disclosure;

FIG. 8 is a flow chart showing operation of another example of the display device according to the first embodiment of the present disclosure;

FIG. 9 is a block diagram showing a configuration of a display system including a display device according to a second embodiment of the present disclosure;

FIG. 10 is a diagram showing a configuration of an operation history table in which an operation history of an apparatus is stored;

FIG. 11 is a block diagram showing a configuration of a display system including a display device according to a third embodiment of the present disclosure;

FIG. 12 is a diagram showing a configuration of a user related information table in which user related information is stored;

FIG. 13 is a flow chart showing operation of the display device according to the third embodiment of the present disclosure;

FIG. 14 is a diagram showing a configuration of a user related information table according to a modification of the third embodiment of the present disclosure; and

FIG. 15 is a block diagram showing a configuration of a display system including a display device according to a fourth embodiment of the present disclosure.

### DESCRIPTION OF EMBODIMENTS

### (Knowledge Underlying Present Invention)

The inventors of the present invention have studied a display device which is buried in an inside wall of a building such as a house and is capable of displaying a list of states of all apparatuses installed in the building and also capable of conducting operation of the apparatuses as necessary. In such a display device, because a display region is limited, when detailed contents of a state of each apparatus are displayed, the states of all the apparatuses could not be displayed in a display region at once, so that a user cannot take bird's-eye view of the states of all the apparatuses.

In this case, a display screen can be configured to be scrollable to present the states of all the apparatuses to a user. However, this configuration gives a burden on a user because a user away from the display device needs to move to the front of the display device and conducting operation of scrolling the screen. Additionally, since the states of all the apparatuses are displayed in the display region at once, when detailed contents of a state of the apparatus are displayed in a small size, a user away from the display device could not visually check the contents.

On the other hand, in a case where a user operates a certain apparatus or checks a state thereof, it is desirable to display the state of the apparatus in detailed contents. Thus, a problem for the display device studied by the present inventors is how bird's-eye view properties and minuteness are combined without requiring user's input of burdensome operation when displaying a state of each apparatus.

Since the user is unlikely to operate a specific apparatus or check a state thereof when a user is away from the display device, it is not necessary to display the state of the apparatus in detailed contents. In this case, it is rather better to limit displaying of states of the apparatus to minimum required contents such as on/off because the states of all the apparatuses can be displayed in the display region at once to ensure bird's-eye view properties.

By contrast, the user is highly likely to operate a specific apparatus or check a state thereof when a user approaches the display device. In this case, by narrowing apparatuses whose states are to be displayed down to apparatuses which are highly likely to be operated or whose states are highly likely to be checked by a user, detailed contents relative to the state of the apparatus can be displayed large in the display region to ensure minuteness.

The present inventors therefore have obtained knowledge that when a user approaches a display device, by narrowing down the number of apparatuses whose states are to be displayed, bird's-eye view properties and minuteness can be ensured without requiring user's input of burdensome operation.

In JP 2008-46934 A, since a user needs to click an icon of the household electrical appliance when displaying history information of a certain household electrical appliance, a user needs to perform a burdensome operation. Additionally, in JP 2008-46934 A, since information is additionally displayed that an icon of the household electrical appliance which is displayed on the top screen is yet to be read, the icon should be displayed in an increased size which enables a user away from the household electrical appliance to visually check the information. Therefore, when a display region is limited, icons of all the household electrical appliances could not be displayed in the display region at once, so that bird's-eye view properties cannot be ensured.

Additionally, in JP 2013-146375 A, images determined in advance according to distances are simply switched and displayed, such as a house appearance image when a user's distance to the game board is large, and an indoor image when the distance is small, and contents of a displayed image are not related to a state of the apparatus. Therefore, J P 2013-146375 A does not have a technical idea of narrowing down the number of apparatuses whose states are to be displayed when a user approaches the display device.

JP 2010-4118 A discloses switching a display screen from an ordinary image to a detailed image as a user's distance to a display section becomes shorter. However, the ordinary image is an image symbolically showing weather on a certain day and the detailed image is an image showing weather in each time zone of the day by using letters, the ordinary image and the detailed image having completely different display forms, and contents of an image to be displayed are not related to a state of the apparatus. Accordingly, J P 2010-4118 A does not have a technical idea of narrowing down the number of apparatuses whose states are to be displayed when a user approaches the display device.

JP 5423183 B2 does not have a technical idea of narrowing down the number of apparatuses whose states are to be displayed when a user approaches the display device because the number of thumbnail image to be displayed is increased as a viewer approaches the display device.

In JP 2003-280803 A, when a pen is brought closer to the input unit, an image operable by the pen is displayed. However, an image to be displayed when the pen comes closer and an image to be displayed when the pen is moved away from the pen have different display forms, and images to be displayed are images related electronic mail. Accordingly, JP 2003-280803 A does not have a technical idea of narrowing down the number of apparatuses whose states are to be displayed when a user approaches.

Thus, the above conventional techniques have the technical ideas different from that of the present disclosure, and it is therefore impossible to display a state of an apparatus so as to ensure bird's-eye view properties and minuteness without imposing burdensome operation on a user.

The present disclosure has been made for solving the above problems, and an object thereof is to enable display of a state of an apparatus so as to ensure bird's-eye view properties and minuteness without imposing burdensome operation on a user.

A display method according to one aspect of the present disclosure is a display method in a display device installed in a building, the display method including, by a processor of the display device: obtaining distance information acquired using a sensor, the distance information being indicative of a distance between the display device and a user; obtaining a state of a first number of apparatuses installed in the building by using a communication device; when a distance indicated by the distance information is greater than or equal to a first reference distance, displaying, in a display, a second number of first objects each corresponding to each or a plurality of the first number of apparatuses and indicative of a state of the corresponding apparatus; and when a distance indicated by the distance information is less than the first reference distance, selecting, a third number of apparatuses from among the first number of apparatuses according to a predetermined condition, the third number being smaller than the first number, to display, in the display, a fourth number of second objects each corresponding to each or a plurality of the third number of apparatuses and indicative of a state of the corresponding apparatus.

With this configuration, in a case where a user's distance to the display device is greater than or equal to the first reference distance, the second number of first objects are displayed. Here, the first object is an image corresponding to each or a plurality of the first number of apparatuses installed in a building and indicative of a state of the corresponding apparatus. Thus, this enables states of the first number of apparatus installed in a building to be displayed in a list on the display using the second number of first objects in a case where a user is away from the display device. Therefore, a user is allowed to grasp all the states of the first number of apparatuses installed in a building without moving to the display device to conduct burdensome operation such as scrolling operation, thereby ensuring bird's-eye view properties. In a case where the first objects one-to-one correspond to the apparatus installed in a building, the second number is equal to the first number, and in a case where the first objects do not one-to-one correspond to the apparatus installed in the building, the second number is smaller than the first number.

By contrast, in a case where a user's distance to the display device is less than the first reference distance, the third number (<the first number) of apparatuses satisfying a predetermined condition are selected and the fourth number of second objects each corresponding to each or a plurality of the third number of apparatuses are displayed in the display. Thus, in a case where a user is close to the display device, the number of apparatuses whose states are to be displayed are narrowed down as compared to a case where a user is away from the display device. Therefore, a larger amount of information about states can be indicated in the second object than in the first object, resulting in ensuring minuteness. In a case where the second objects one-to-one correspond to the selected apparatuses, the fourth number is equal to the third number and in a case where the second objects do not one-to-one correspond to the selected apparatuses, the fourth number is smaller than the third number.

As described above, this configuration enables bird's-eye view properties and minuteness to be ensured without requiring user's input of burdensome operation.

In the above aspect, an amount of information about a state of the apparatus indicated by the second object may be larger than an amount of information about a state of the apparatus indicated by the first object.

With this configuration, since an amount of information about a state of the apparatus indicated by the second object is larger than that indicated by the first object, it is possible to present necessary information to a user who approaches the display device to operate an apparatus or check a state thereof, thereby ensuring minuteness. It is also possible to limit the amount of information about states of the apparatuses indicated in the first object to minimum required contents, thereby enabling bird's-eye view properties to be ensured.

In the above aspect, the display method may further include obtaining apparatus information indicative of a distance of the first number of apparatuses to the display device, and specifying the apparatus at a distance from the display device of less than a second reference distance based on the apparatus information to select the specified apparatus as the apparatus satisfying the predetermined condition.

When a user approaches the display device, an apparatus installed near the display device is highly likely to be operated or have a state thereof checked. With this configuration, since an apparatus installed at a distance from the display device of less than the second reference distance is selected in a case where a user's distance to the display device is less than or equal to the first reference distance, the second object for an apparatus which is highly likely to be operated or have a state thereof checked by a user can be displayed.

In the above aspect, the display method may further include obtaining operation histories of the first number of apparatuses, and specifying the apparatus operated in a predetermined time zone including current time based on the operation histories to select the specified apparatus as the apparatus satisfying the predetermined condition.

A user tends to operate a certain apparatus in the same time zone. With this configuration, since an apparatus operated in a predetermined time zone including current time is selected in a case where a user's distance to the display device is less than the first reference distance, the second object which is highly likely to be operated by a user at present can be displayed.

In the above aspect, the display method may further include obtaining apparatus information in which an installation position and a type of the installation position of each of the first number of apparatuses are associated with each other, and specifying an apparatus having the same type of installation position as a type of installation position of the display device based on the apparatus information, to select the specified apparatus as the apparatus satisfying the predetermined condition.

When a user approaches the display device, for example, an apparatus installed in the same room as the display device is highly likely to be operated or have a state thereof checked. With this configuration, since an apparatus having the same type of installation position as that of the display device is selected in a case where a user's distance to the display device is less than the first reference distance, a second object for an apparatus which is highly likely to be operated or have a state thereof checked by a user can be displayed.

In the above aspect, the display method may further include obtaining operation histories of the first number of apparatuses, and specifying the apparatus constantly energized based on the operation histories to select the specified apparatus as the apparatus not satisfying the predetermined condition.

For example, a user tends to refrain from operating such an apparatus or checking a state thereof as a refrigerator which is obvious to be energized constantly. With this configuration, since the constantly energized apparatus will not be selected in a case where a user's distance to the display device is less than the first reference distance, it is possible to prevent displaying of the second object of an apparatus which is less likely to be operated or have a state thereof checked by a user.

In the above aspect, the display method may further include obtaining identification information of the user based on voice or an image of the user, in which the predetermined condition may be a condition in accordance with the identification information.

With this configuration, since an apparatus in accordance with identification information of the user is selected as an apparatus satisfying a predetermined condition in a case where a user's distance to the display device is less than the first reference distance, only the second object for an apparatus which is highly likely to be operated or have a state thereof checked by a user can be displayed.

In the above aspect, the display method may further include obtaining user related information in which the identification information of the user and one or more of the first number of apparatuses are associated with each other, and specifying the apparatus corresponding to the user based on the identification information and the user related information to select the specified apparatus as the apparatus satisfying the predetermined condition.

With this configuration, since an apparatus associated in advance with a user around the display device is selected in a case where a user's distance to the display device is less than the first reference distance, an apparatus which is highly likely to be operated or have a state thereof checked by a user can be selected by determining an apparatus which is highly likely to be operated or have a state thereof checked by a user in advance.

In the above aspect, the display method may further include obtaining an operation history including an operation history of the user for each of the first number of apparatuses, and specifying an apparatus with a frequency of use by the user of greater than or equal to a reference frequency determined in advance based on the identification information and the operation history to select the specified apparatus as the apparatus satisfying the predetermined condition.

With this configuration, since an apparatus with a high frequency of use by a user is selected in a case where a user's distance to the display device is less than the first reference distance, an apparatus which is highly likely to be operated or have a state thereof checked by a user can be selected.

In the above aspect, the display method may further include obtaining user related information in which an attribute of the user and one or more of the first number of apparatuses are associated with each other, and specifying an attribute of the user from the identification information, and based on the specified attribute of the user and the user related information, specify the apparatus corresponding to the attribute of the user to select the specified apparatus as the apparatus satisfying the predetermined condition.

An apparatus which is operated or whose state is checked by a user in general varies with an attribute of the user such as child, adult, female, or male. With this configuration, since an apparatus determined in advance according to an attribute of the user is selected in a case where a user's distance to the display device is less than or equal to the first reference distance, an apparatus which is highly likely to be operated or have a state thereof checked by a user can be selected according to the attribute of the user.

In the above aspect, further, in a case where a distance indicated by the distance information is greater than or equal to a third reference distance which is larger than the first reference distance, the first object may not be displayed.

With this configuration, since the first object will not be displayed in a case where a distance to the display device is greater than or equal to the third reference distance, when, for example, a user is far away from the display device and apparently has no intention to check a state of an apparatus, power consumption can be reduced by refraining from displaying the first object.

In the above aspect, the first object may be displayed in a color corresponding to an operation state.

With this configuration, since an operation state of the first object is presented by color, an operation state of the first object can be visually recognized by a user away from the display device.

The foregoing operations and effects can be obtained similarly by the display device and the display program of the present disclosure.

The present disclosure can be realized as a display program which causes a computer to execute each characteristic configuration included in such a display method as described above, or as a display system operable by the display program. It goes without saying that such a display program can be distributed via a computer-readable non-transitory recording medium such as a CD-ROM or via a communication network such as the Internet.

Embodiments to be described in the following each show one specific example of the present disclosure. Numerical values, shapes, constituent elements, steps, orders of steps, and the like shown in the embodiments below are each one example only and do not limit the present disclosure. Among constituent elements in the embodiments below, those not recited in an independent claim showing a most significant concept will be described as arbitrary constituent elements. Additionally, in all the embodiments, respective contents can be combined.

### First Embodiment

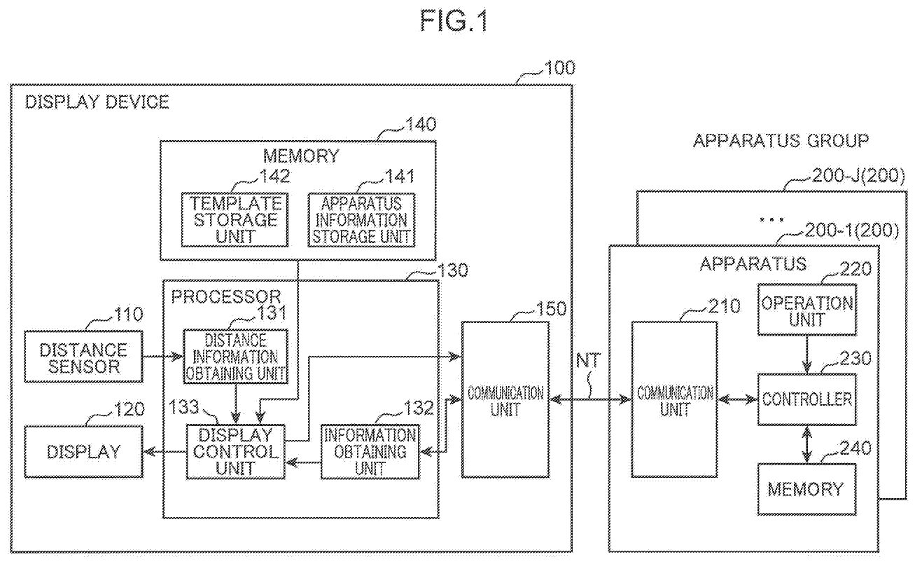

FIG. 1 is a block diagram showing a configuration of a display system including a display device 100 according to a first embodiment of the present disclosure. The display system shown in FIG. 1 includes the display device 100 and an apparatus group including a number J (J is an integer of one or more) of apparatuses 200_1 to 200_J. Hereinafter, when collectively referring to the apparatuses 200_1 to 200_J, a reference sign “200” is attached.

The display system is a system which is installed in, for example, a building such as a house or an office building and presents a state of the apparatus 200 to a user through the display device 100. The display system is also capable of accepting operation of a certain apparatus 200 by a user through the display device 100 and causing the user to remotely operate the apparatus 200 in question.

The house is, for example, a collective housing or a detached house. The display device 100 is, for example, a panel type display device buried in an inside wall of a building. However, this is one example and the display device 100 may be configured with a floor-mounted display device or mounted on an existing television. Although FIG. 1 shows one display device 100, this is one example, and one display device can be provided in each of a plurality of rooms, for example, one in a living room, one in an entrance, one in a kitchen, one in each of a plurality of bed rooms, and one in a bathroom, or can be provided in each of two or more of a plurality of rooms. In other words, the display system can be configured with a plurality of display devices 100.

The apparatus 200 is an electric appliance for domestic use such as an illumination apparatus, a television, an air conditioner, a refrigerator, a microwave oven, an IH cooker, a washing machine, or the like.

The display device 100 and the apparatus 200 are communicably connected with each other via a communication network NT. Here, as the communication network NT, a local network such as wired LAN or wireless LAN is adopted.

The display device 100 includes a distance sensor 110 (one example of a sensor), a display 120, a processor 130, a memory 140, and a communication unit 150. The distance sensor 110, which is configured with, e.g., a three-dimensional distance sensor disposed on a surface of the display device 100, obtains distance information indicative of a distance between a user present around the display device 100 and the display device 100 at a predetermined frame rate (e.g., 30 frames per second). Here, the distance sensor 110 can be configured with a TOF (Time of Flight) system three-dimensional distance sensor, or with a stereo camera. In any case, the distance sensor 110 obtains a three-dimensional distance image indicative of environments around the display device 100. Then, by extracting a user from the distance image, the distance sensor 110 obtains distance information indicative of a distance of the user. Here, when a plurality of users are included in the distance image, the distance sensor 110 only needs to obtain distance information of a closest user.

The display 120 is configured with a display device such as a liquid crystal display, an organic EL display, or the like. In the present embodiment, the display 120 displays state display contents indicative of a state of the apparatus 200 under the control of a display control unit 133 to be described later. Additionally, the display 120 has a touch panel adhered thereto and is also capable of accepting operation for the apparatus 200 from a user.

The processor 130 is configured with an electric circuit such as a CPU or an ASIC, and includes a distance information obtaining unit 131, an information obtaining unit 132, and the display control unit 133. Each block constituting the processor 130 may be realized by execution of a display program by a CPU, the display program causing a computer to function as the display device 100 or may be configured with a dedicated electric circuit.

The distance information obtaining unit 131 obtains distance information indicative of a distance between the display device 100 and a user from the distance sensor 110, and outputs the distance information to the display control unit 133. Since the distance sensor 110 outputs distance information at a predetermined frame rate, the distance information obtaining unit 131 will obtain the distance information at the predetermined frame rate. Although in the above description, processing of extracting a user from a distance image to obtain distance information of the user is conducted by the distance sensor 110, the present disclosure is not limited thereto, and the processing can be conducted by the distance information obtaining unit 131. In this case, the distance sensor 110 only needs to conduct processing of outputting a distance image to the distance information obtaining unit 131.

The information obtaining unit 132 obtains state information indicative of a current operation state from each apparatus 200 via the communication unit 150 and outputs the obtained state information to the display control unit 133. Here, the information obtaining unit 132 only needs to obtain state information of each apparatus 200 at fixed time intervals. In this case, the information obtaining unit 132 only needs to cause the communication unit 150 to transmit a request for obtaining state information at fixed time intervals and cause each apparatus 200 to return the state information. Alternatively, the information obtaining unit 132 may obtain state information by causing the apparatus 200 to spontaneously transmit state information at fixed time intervals without transmitting an obtaining request by itself.

Alternatively, the information obtaining unit 132 may cause the apparatus 200 to transmit state information, for example, upon acceptance of operation from a user as a trigger, or cause the apparatus 200 to transmit state information, for example, upon switching of a control mode as a trigger. For example, in a washing machine, switching from a washing mode to a rinsing mode corresponds to switching of a control mode, and for example, in a microwave oven, change of a temperature in a chamber etc. corresponds to the switching of the control mode.

The display control unit 133 generates state display contents for displaying a state of each apparatus 200 by using the state information of the apparatus 200 output from the information obtaining unit 132 and displays the state display contents in the display 120. The state display contents can be configured with image data or with a program such as HTML. In a case where the state display contents are configured with HTML, the display control unit 133 only needs to convert the state display contents by using a program such as a browser into image data and then output the obtained data to the display 120.

The display control unit 133 generates different state display contents according to distances indicated by the distance information obtained by the distance information obtaining unit 131. Specifically, when the distance is greater than or equal to the first reference distance, the display control unit 133 generates a first content as a state display content for remote display which indicates each state of a number J of the apparatuses 200 by using the number J of first objects corresponding to the number J of apparatuses 200 and causes the display 120 to display the generated first content.

On the other hand, when the distance is less than the first reference distance, the display control unit 133 selects a number L (L is an integer of one or more and less than J) of the apparatuses 200 satisfying a predetermined condition, generates a second content as a state display content for nearby display which indicates each state of the number L of apparatuses 200 by using second objects corresponding to the number L of apparatuses 200, and causes the display 120 to display the generated second content. The number J is one example of a first number and a second number and the number L is one example of a third number and a fourth number. Although in the present embodiment, the first objects one-to-one correspond to the number J of apparatuses 200, this is one example. For example, it is possible to set the total number of first objects to be J′ which is smaller than J, make a number j (j is an integer of 0 or more and less than J′) of the first objects indicative of states of a plurality of apparatuses correspond to a part of the number J of apparatuses 200, and make a number J′-j of the first objects indicative of a state of one apparatus 200 correspond to the remaining apparatuses 200. In this case, J is one example of the first number and J′ is one example of the second number.

Also, while in the present embodiment, the second objects one-to-one correspond to the number L of apparatuses 200, this is one example. For example, it is possible to set the total number of second objects to be L′ which is smaller than L, make a number 1 (1 is an integer of 0 or more and less than L′) of the second objects indicative of a plurality of apparatuses 200 correspond to a part of the number L of apparatuses 200, and make a number L′-1 of the second objects indicative of a state of one apparatus 200 correspond to the remaining apparatuses 200. In this case, the number L is one example of the third number and the number L′ is one example of the fourth number.

The memory 140 is configured with a non-volatile memory and includes an apparatus information storage unit 141 and a template storage unit 142. The apparatus information storage unit 141 stores apparatus information in which an installation position of each of the number J of apparatuses 200 and a type of the installation position are associated with each other.

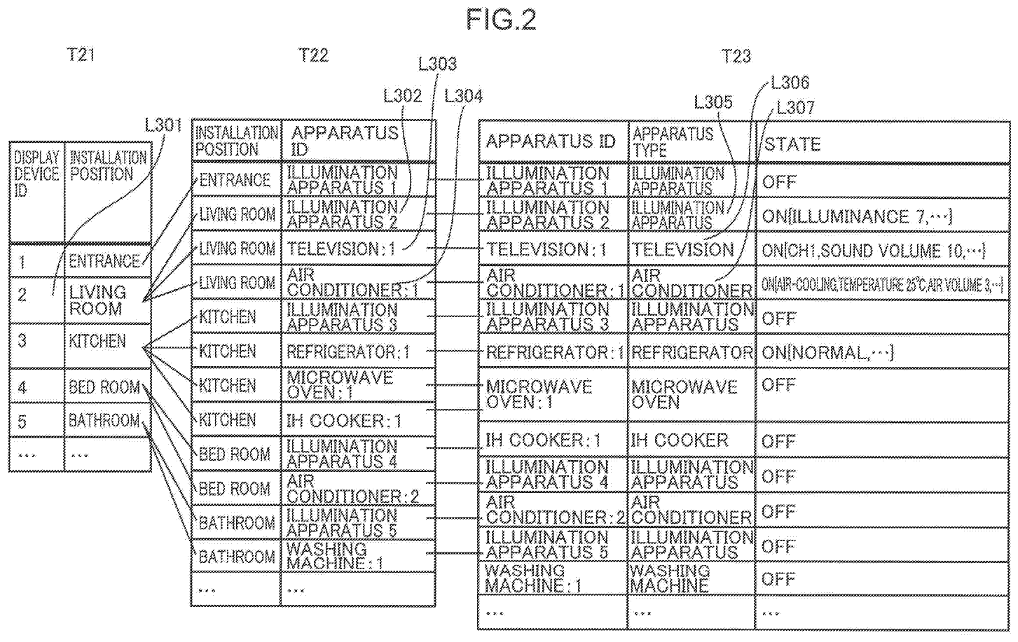

FIG. 2 is a diagram showing one example of a configuration of apparatus information and state information. The apparatus information includes a first apparatus table T21 and a second apparatus table T22. The first apparatus table T21 is a table in which an installation place of each of one or more display devices 100 is stored, with “display device ID” and “installation place” being associated with each other. “Display device ID” is an identifier for identifying each of the plurality of display devices 100. “Installation place” indicates a name of a room in which each display device 100 is installed. For example, the display device 100 with the display device ID “2” in the second line (line L301) is installed in a living room.

The second apparatus table T22 is a table in which the apparatuses 200 installed at a plurality of installation places are stored, “installation place” and “apparatus ID” being associated with each other. “Installation place” is the same as in the first apparatus table T21. “Apparatus ID” is an identifier for identifying each of the plurality of apparatuses 200. For example, it is indicated in the second line (line L302) that an illumination apparatus with an apparatus ID “illumination apparatus: 2” is installed in the installation place “living room”, in the third line (line L303) that a television with an apparatus ID “television: 1” is installed in the installation place “living room”, and in the fourth line (line L304) that an air conditioner with an apparatus ID “air conditioner: 1” is installed in the installation place “living room”.

A state information table T23 is a table including state information indicative of a current state of each of the plurality of apparatuses 200 obtained by the information obtaining unit 132. The state information table T23 stores “apparatus ID”, “apparatus type”, and “state” so as to be associated with each other. “Apparatus ID” is the same as that in the second apparatus table T22. “Apparatus type” indicates a type of each of the plurality of apparatuses 200 such as an illumination apparatus, a television, an air conditioner, and the like. “State” indicates a current state of each of the plurality of apparatuses 200.

For example, it is indicated in the second line (line L305) that the apparatus 200 with the apparatus ID “illumination apparatus: 2” has an apparatus type of “illumination apparatus” and is in a state of “ON” and illuminance of “7”. It is indicated in the third line (line L306) that the apparatus 200 with the apparatus ID “television: 1” has an apparatus type of “television” and is in the state of “ON”, a channel “1”, and a sound volume of “10”. Also, it is indicated in the fourth line (line L307) that the apparatus 200 with the apparatus ID “air conditioner: 1” has an apparatus type of “air conditioner”, and is in the state of “ON”, “air-cooling” operation, temperature setting of “25° C.”, and air volume setting of “3”.

Reference is made again to FIG. 1. For example, in a case where a mode of obtaining state information from the apparatus 200 in a predetermined cycle is adopted, the information obtaining unit 132 only needs to put obtained state information together every time the state information is obtained to generate the state information table T23. In a case where a mode of spontaneously transmitting state information by the apparatus 200 is adopted, the information obtaining unit 132 can generate the state information table T23 such that latest state information of each of the plurality of apparatuses 200 is included. The information obtaining unit 132 also can cause the memory 140 to store the generated state information table T23.

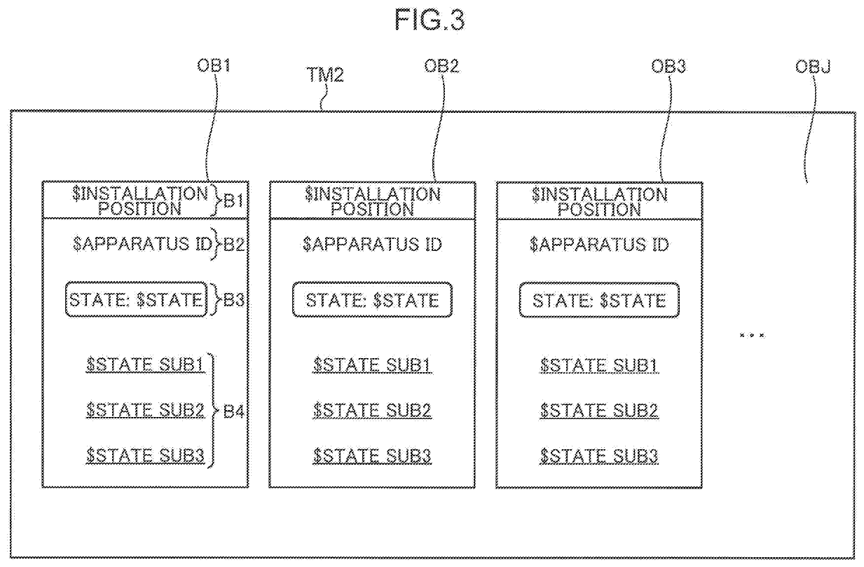

The template storage unit 142 stores a first template image for use in generating the first content and a second template image for use in generating the second content. FIG. 3 is a diagram showing a configuration of a second template image TM2. In the second template image TM2, the number J of second objects OB1, OB2, . . . , OBJ are laterally aligned, for example. Hereinafter, when the second objects OB1, OB2, . . . , OBJ are collectively referred to, a reference sign “OB” will be attached to a second object. Here, although in the second template image TM2, the number J of second objects OB are aligned to correspond to all the apparatuses 200, in the second content generated from the second template image TM2, the number L of second objects OB satisfying a predetermined condition which are selected from the number J of apparatuses 200 by the display control unit 133 are aligned. The second objects OB are each configured with a card-shaped (square shape) image displaying a state of the corresponding apparatus 200. The second objects OB each have the same size.

Specifically, the second object OB has a display field B1 for an installation place indicated by “$installation place”, a display field B2 arranged below the display field B1 and for an apparatus ID indicated by “$apparatus ID”, a display field B3 arranged below the display field B2 and for a main state indicated by “state: $state”, and a display field B4 arranged below the display field B3 and for sub-states indicated by “$state sub1”, “$state sub2”, and “$state sub3”. The main state is a state of the apparatus 200 indicated also in the first object OA, the main state corresponding to a basic state of the apparatus 200, e.g., ON and OFF or the like.

The sub-state is a state of the apparatus 200 accompanying the main state and varying with, for example, each apparatus 200. For example, in a case of an illumination apparatus, illuminance, tint, and the like correspond to the sub-states, in a case of a television, a channel, a sound volume, and the like correspond to the sub-states, and in a case of an air conditioner, an operation mode such as air-cooling and heating, temperature setting, an air volume, and the like correspond to the sub-states.

The display control unit 133 selects data to be inserted in the display fields B1 to B4 of the second template image TM2 from the second apparatus table T22 and the state information table T23 and inserts the selected data to the second template image TM2 to generate a second content.

For example, in an example on the line L305 in the state information table T23, first, in the “state” field, “ON” is listed and then illuminance “7” is listed in parentheses. Therefore, the display control unit 133 specifies “ON” listed first as a main state and illuminance “7” as a sub-state and inserts them in the display fields B3 and B4, respectively.

In other words, the display control unit 133 determines, by the listing order of data, which information corresponds to the main state among information listed in the “state” field of the state information table T23 and which information corresponds to the sub-state.

In the example of the second template image TM2 in FIG. 3, the display field B4 is provided with three sub-state display fields. Therefore, the display control unit 133 can insert the maximum of three sub-states in the display field B4. In this case, with respect to the apparatus 200 for which only one information is listed as a sub-state like the illumination apparatus in the line L305 in the state information table T23, only one sub-state is listed. With respect to the apparatus 200 for which four or more sub-states are listed in the state information table T23, top three sub-states are inserted in the display field B4 in the listing order. Additionally, in the display field B4, top sub-states are sequentially inserted.

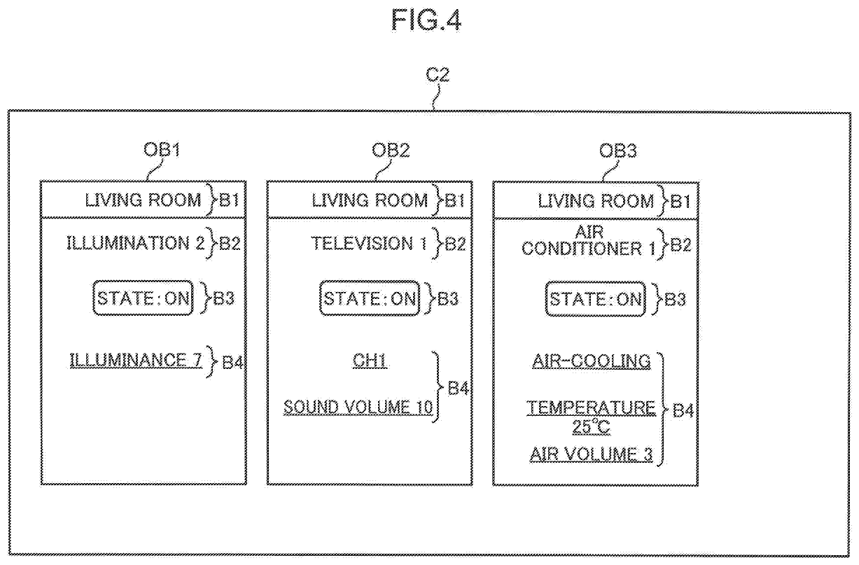

FIG. 4 is a diagram showing a configuration of a second content C2. The second content C2 is generated by inserting various types of information in the display fields B1 to B4 of the second template image TM2. In the example of FIG. 4, since the apparatus 200 installed in the living room is selected as an apparatus 200 satisfying a predetermined condition, the state of the apparatus 200 installed in the living room is displayed. Specifically, in the second apparatus table T22, an illumination apparatus with the apparatus ID “illumination apparatus: 2”, a television with the apparatus ID “television: 1”, and an air conditioner with the apparatus ID “air conditioner: 1” are associated with the living room. Therefore, the second objects OB corresponding to the three apparatuses 200 are displayed in FIG. 4.

Since these three second objects OB correspond to the apparatuses 200 all installed in the living room, “living room” is displayed in the display field B1. With respect to, for example, a television with the apparatus ID “television: 1”, since “ON” indicating that a power supply is turned on is listed as a main state in the state information table T23, “state: ON” is displayed in the display field B3. Also with respect to the television, since channel “1” and sound volume “10” are included as sub-states in the state information table T23, these two sub-states are displayed in the display field B4.

Although the second objects OB here are displayed laterally in a row, this is one example, and they can be displayed vertically in a row or can be displayed in a matrix of predetermined rows×predetermined columns. Additionally, the display order of the second objects OB only needs to follow, for example, the listing order in the second apparatus table T22. The shape of the second object OB is not limited to square, and various shapes can be adopted such as circle, oval, rhomb, and the like. The second object OB may also include an operation button for remotely operating the corresponding apparatus 200. For example, in a second object OB corresponding to the illumination apparatus, an ON/OFF button, and a button for adjusting illuminance may be included, and in a second object OB corresponding to the television, the ON/OFF button, a button for adjusting a channel, and a button for adjusting a sound volume may be included. In this case, when the operation button displayed in the second object OB is touched, the display control unit 133 only needs to transmit an operation command associated with the operation button to the apparatus 200 via the communication unit 150 to remotely control the apparatus 200.

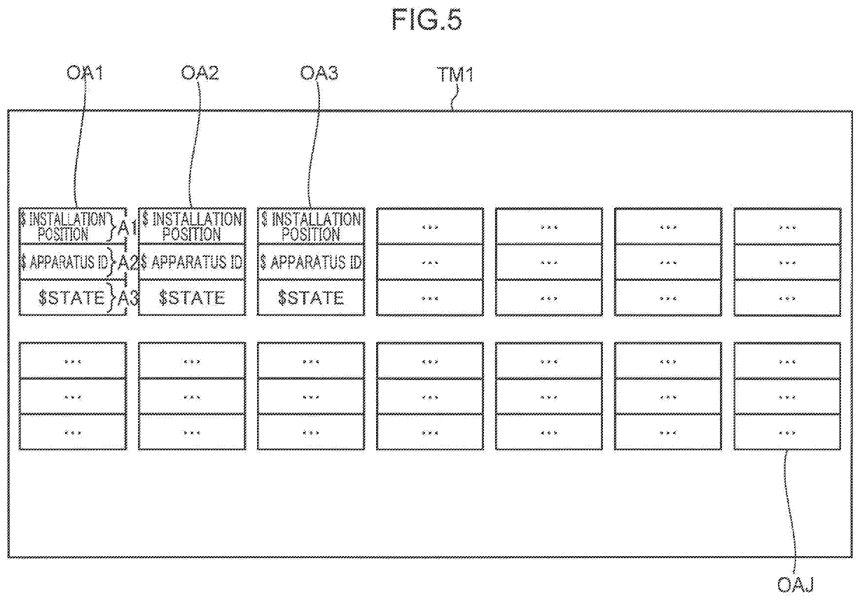

FIG. 5 is a diagram showing a configuration of a first template image TM1. In the first template image TM1, the number J of first objects OA1, OA2, . . . , OAJ are aligned, for example, laterally in two rows. Hereinafter, when the first objects OA1, OA2, . . . , OAJ are collectively referred to, a reference sign “OA” will be attached to a first object. Although the first objects OA are each configured with a card-shaped (square shape) image of the same size displaying a state of the corresponding apparatus 200 similarly to the second object OB, the first objects OA are different from the second objects OB in that the displayed states are more simplified.

Specifically, the first object OA has a display field A1 for an installation place indicated by “$installation place”, a display field A2 arranged below the display field A1 and for an apparatus ID indicated by “$apparatus ID”, and a display field A3 arranged below the display field A2 and for a main state indicated by “state: $state”. In other words, the display field B4 for a sub-state which is displayed in the second object OB is omitted from the first object OA. The remaining part of the contents displayed in the first object OA is the same as that of the second object OB.

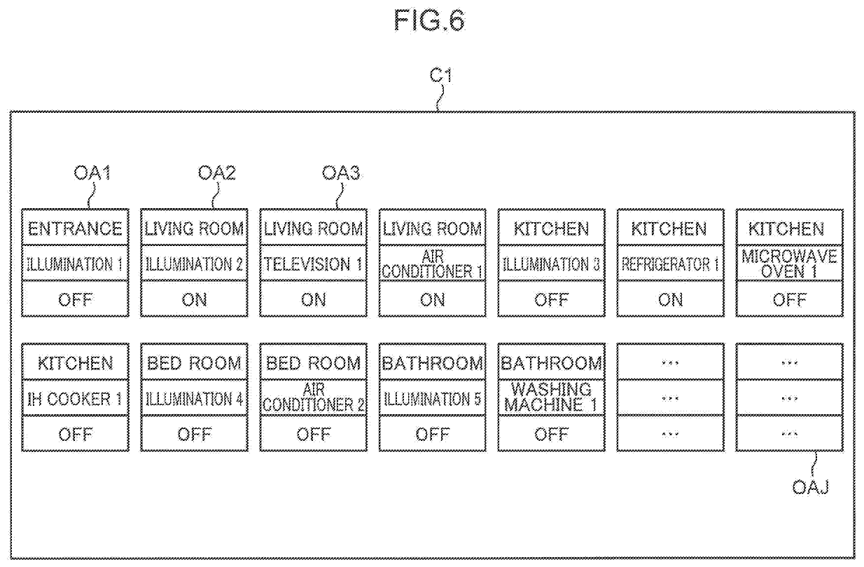

FIG. 6 is a diagram showing a configuration of a first content C1. The first content C1 is generated by inserting various types of information in the display fields A1 to A3 of the first template image TM1. Unlike the second content C2, the first content C1 displays all the states of the number J of apparatuses 200. Therefore, the number of first objects OA displayed in the first content C1 is J, the same as the number in the first template image TM1.

For example, when generating the first content C1, the display control unit 133 only needs to specify apparatus IDs of all the apparatuses 200 listed in the state information table T23 and also specify installation places of all the apparatuses 200 from the second apparatus table T22 to insert the specified results in the display fields A1 and A2 of each first object OA of the first template image TM1. When generating the first content C1, the display control unit 133 also only needs to specify, with respect to all the apparatuses 200 listed in the state information table T23, a main state from information stored in the “state” field and insert the specified result in the display field A3 of each first object OA of the first template image TM1.

Thus, a sub-state display field is omitted from the first object OA and an amount of information displayed in the first object OA is set to be smaller than an amount of information displayed in the second object OB. It is therefore possible to reduce the size of the first object OA such that the number J of first objects OA can be displayed at once in a display region of the display 120. Therefore, a user is allowed to grasp all the main states of the number J of apparatuses 200 at sight from a place away from the display device 100 without moving to the display device 100 to input operation of scrolling the first content C1 or the like, thereby ensuring bird's-eye view properties.

On the other hand, since the amount of information displayed in the second object OB is larger than that in the first object OA, it is possible to present necessary information to a user who approaches the display device 100 to check a state of a certain apparatus 200 or operate the apparatus, thereby ensuring minuteness. The shape of the first object OA is not limited to square, and various shapes can be adopted such as circle, oval, rhomb, and the like. Additionally, although in the example of FIG. 6, the first objects OA are displayed laterally in two rows, this is one example and the first objects can be displayed laterally in three or more rows, laterally in a row, vertically in a row, or vertically in two or more rows.

Reference is made again to FIG. 1. The communication unit 150 is configured with a communication device for connecting the display device 100 to the communication network NT. In the present embodiment, the communication unit 150, for example, transmits a request for obtaining state information to the apparatus 200, receives state information transmitted from the apparatus 200, and transmits an operation command to the apparatus 200.

The apparatus 200 includes a communication unit 210, an operation unit 220, a controller 230, and a memory 240. The communication unit 210 is configured with a communication device which connects the apparatus 200 to the communication network NT. The operation unit 220 accepts operation of the apparatus 200 by a user. The controller 230 is an electric circuit which controls the apparatus 200. The memory 240 is configured with a non-volatile memory and stores a control program of the apparatus 200, an operation log of the apparatus 200, and the like. In FIG. 1, only a basic configuration commonly provided in all the apparatuses 200 is illustrated and illustration of a configuration inherent to the apparatuses is omitted.

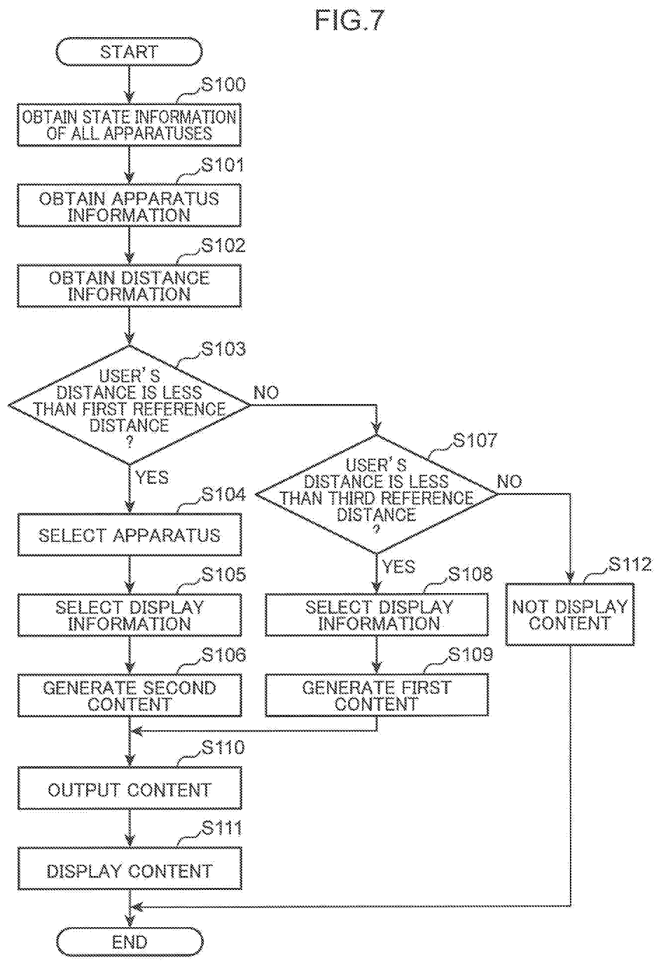

Next, operation of the display device 100 shown in FIG. 1 will be described. FIG. 7 is a flow chart showing operation of the display device 100 according to the first embodiment of the present disclosure.

The flow in FIG. 7 will be repeated, for example, at a fixed time interval. First, in S100, the information obtaining unit 132 obtains the state information of all the number J of apparatuses 200 using the communication unit 150, generates such state information table T23 as shown in FIG. 3, and outputs the generated table to the display control unit 133.

In S101, the display control unit 133 obtains apparatus information from the memory 140. In this manner, the first apparatus table T21 and the second apparatus table T22 shown in FIG. 2 are obtained.

In S102, the distance sensor 110 obtains distance information indicative of a distance of a user to the display device 100 and outputs the obtained information to the distance information obtaining unit 131.

In S103, the display control unit 133 determines whether or not a distance of a user indicated by the distance information is less than the first reference distance. When the distance is less than the first reference distance (YES in S103), the processing proceeds to S104, and when the distance is greater than or equal to the first reference distance (NO in S103), the processing proceeds to S107. Here, as the first reference distance, e.g., a distance determined in advance is adopted by which a user can be considered to be approaching the display device 100 to check a state of the apparatus 200 or operate the same, the distance being e.g., 1.5 m. However, this is one example and such values 50 cm, 1.0 m, 2.0 m can be adopted as the first reference distance. The first reference distance can be configured to be arbitrarily set by a user. This enables a user to set, as the first reference distance, a distance appropriate for a size of a room in which the display device 100 is installed.

In S104, the display control unit 133 selects the number L of apparatuses 200 satisfying a predetermined condition from among the number J of apparatuses 200. Here, the display control unit 133 only needs to select the apparatus 200 installed in the same room as a room in which the display device 100 is installed as an apparatus 200 satisfying the predetermined condition. Specifically, the display control unit 133 only needs to select an apparatus 200 by referring to the first apparatus table T21 to specify an installation place of the display device 100 to which the display control unit belongs with a display device ID as a key and then referring to the second apparatus table T22 to specify an apparatus 200 installed in the specified installation place. In the example of FIG. 2, assuming, for example, that a display device 100 is the display device 100 installed in the living room shown in the line L301, an illumination apparatus with the apparatus ID “illumination apparatus: 2”, a television with the apparatus ID “television: 1”, and an air conditioner with the apparatus ID “air conditioner: 1” installed in the living room indicated in the lines L302, L303, and L304 are selected.

“Installation place” in the first apparatus table T21 is one example of a type of installation position for the display device 100, and “installation place” in the second apparatus table T22 is one example of a type of installation position for the apparatus 200.

Here, although as a predetermined condition, a condition for selecting an apparatus 200 installed in the same room as the display device 100 is adopted, the present disclosure is not limited thereto.

For example, as a predetermined condition, a condition can be adopted that an apparatus 200 is selected which is installed at a position at a distance from the display device 100 of less than a second reference distance. In this case, as an “installation place” in the first apparatus table T21 shown in FIG. 2, coordinates indicative of an installation position of the display device 100 only needs to be adopted instead of a name of an installation place. Similarly, as an “installation place” in the second apparatus table T22 shown in FIG. 2, coordinates indicative of an installation position of the apparatus 200 only needs to be adopted instead of a name of an installation place. Here, as coordinates, two-dimensional coordinates can be adopted which indicate installation places of the display device 100 and the apparatus 200 in a floor plan of a building in which two-dimensional coordinate axes are set. In this case, the display control unit 133 only needs to specify coordinates of the display device 100 to which the display control unit belongs from the first apparatus table T21 and specify coordinates of each apparatus 200 from the second apparatus table T22 to obtain a distance between the display device 100 and each apparatus 200 and select an apparatus 200 having a distance of less than the second reference distance as an apparatus 200 satisfying the predetermined condition. As the second reference distance, appropriate values such as 2 m, 3 m, and the like can be adopted according to a room in which the display device 100 is installed. As the second reference distance, a different value can be set for each display device 100 or the same value can be uniformly adopted. The second reference distance can be also configured to be arbitrarily changeable by a user.

For example, when a user approaches the display device 100, the user is highly likely to operate the apparatus 200 installed near the display device 100 (e.g., in the same room) or check a state of the apparatus. Therefore, in the present embodiment, as a predetermined condition, a condition is adopted that an apparatus 200 installed in the same room as the display device 100 or an apparatus 200 at a position at a distance from the display device 100 of less than the second reference distance is selected. As a result, a second object OB indicative of a state of the apparatus 200 whose state is highly likely to be checked or which is highly likely to be operated by a user is displayed in the second content C2 to enable the user to check a state of a desired apparatus 200 without requiring user's input of extra operation.

In S105, the display control unit 133 selects display information to be displayed in the second content with respect to the selected apparatus 200. For example, assuming that in the second apparatus table T22, three apparatuses 200 indicated in lines L302, L303, and L304 are selected, “installation place”, “apparatus ID”, “main state”, and “sub-state” of these three apparatuses 200 are selected as display information. As to which of sub-states included in the state information is selected as display information, top three sub-states listed in the parentheses in the “state” field of the state information table T23 are adopted as described above. However, this is one example. For example, “installation place” can be omitted, or one, two, or four or more sub-states from the top listed in the parentheses in the state information table T23 can be adopted, or one, two, three, or four or more arbitrary sub-states can be adopted among the sub-states listed in the parentheses.

In S106, the display control unit 133 generates the second content C2 by inserting the display information selected in S105 to the relevant display fields B1 to B4 of the second template image TM2. As a result, the second content C2 indicative of a state of the apparatus 200 whose state is highly likely to be checked or which is highly likely to be operated by a user is generated from among the number J of apparatuses 200 as shown in FIG. 4. Although in the example of FIG. 4, because three apparatuses 200 are selected, three second objects OB are displayed, this is one example. In a case where the number L of apparatuses 200 are selected, the number L of the second objects OB are displayed. Also, while in the display field B4 of the second object OB, three lines of display fields are provided, in a case where one sub-state is displayed, a sub-state is displayed only in the first line and the remaining two lines are set to be blank. The same applies to a case where two sub-states are displayed.

Additionally, although in the example of FIG. 4, information listed in the second apparatus table T22 and the state information table T23 are displayed as they are, this is one example and information subjected to some change or another can be displayed. For example, information converted into such a character string as “in operation” can be displayed in place of “ON”.

In S107, the display control unit 133 determines whether or not a distance indicated by the distance information obtained in S102 is less than a third reference distance. When the distance is less than the third reference distance (YES in S107), the display control unit 133 selects display information for the first content C1 (S108). In this case, “installation place”, “apparatus ID”, and “main state” of each of the number J of apparatuses 200 are selected as display information.

Although the description has been made herein of a case where only a main state is displayed in the first content C1, a sub-state can be displayed if there is a margin in a display region of the first object OA. In this case, as to which sub-state is to be displayed, a sub-state determined in advance only needs to be adopted similarly to the second object OB. Additionally, although the description has been made herein of a case where “installation place” and “apparatus ID” are displayed in the first object OA, for example, “installation place” can be omitted.

In S109, the display control unit 133 generates the first content C1 by inserting the information selected in S108 in the relevant display fields A1 to A3 of the first template image TM1. As a result, the first content C1 is generated which displays a list of the number J of apparatuses 200 as shown in FIG. 6.

By contrast, when determination is made in S107 that the user's distance is greater than or equal to the third reference distance (NO in S107), the display control unit 133 ends the processing without displaying any of the first content C1 and the second content C2 (S112). Here, as the third reference distance, a value larger than the first reference distance is adopted. For example, assuming that the user is positioned far away from the display device 100, a distance can be adopted at which a user is unlikely to check a state of an apparatus 200. Also in a case where the distance sensor 110 could not detect a user from a distance image, determination of NO is made in S107. Also in S112, the display control unit 133 can stop power supply to the display 120 to bring the display 120 into a sleep state.

In S110, the display control unit 133 outputs the generated content to the display 120. Here, when the first content C1 is generated, the display control unit 133 outputs the first content C1 to the display 120, and when the second content C2 is generated, the display control unit 133 outputs the second content C2 to the display 120.

In S111, the display 120 displays the first content C1 or the second content C2 to end the processing.

Thus, according to the first embodiment, in a case where a user's distance to the display device 100 is greater than or equal to the first reference distance, the first content C1 including the number J of first objects OA each indicative of a state of each of the number J of apparatuses 200 is displayed in the display 120. Therefore, a user is allowed to grasp states of the first number of apparatuses 200 installed in a building without moving to the display device to conduct burdensome operation such as scroll operation, thereby ensuring bird's-eye view properties. On the other hand, in a case where a user's distance to the display device 100 is less than the first reference distance, the second content C2 including the number L of second objects OB corresponding to the number L of apparatuses 200 satisfying a predetermined condition is displayed in the display 120. As a result, in a case where a user is closer to the display device 100, the number of apparatuses 200 whose states are to be displayed is narrowed down as compared to a case where the user is away from the display device 100. Therefore, an amount of information about a state indicated in the second object OB can be increased to be larger than that of the first object, resulting in ensuring minuteness.

The present embodiment can adopt the following modifications. The modifications below can be appropriately adopted in second to fourth embodiments to be described later.

(1-1) While the above description has been made assuming that the first reference distance is set in advance or can be arbitrarily set by a user, the first reference distance may be automatically set by the display control unit 133. For example, assuming that a floor plan is stored in the memory 140 in advance, the display control unit 133 may specify an area of a room in which the display device 100 is installed from the floor plan and set a value in accordance with the specified area as a first reference distance for the display device 100 installed in the room. In this case, the display control unit 133 only needs to set the first reference distance using a function created in advance for converting an area into the first reference distance.

(1-2) While the above description has been made assuming that a predetermined number of sub-states to be indicated in the second object OB is adopted, the present disclosure is not limited thereto. For example, in a case where the number of second objects OB is so large that displaying all the second objects OB at once in the display region of the display 120 is difficult, the display control unit 133 may appropriately reduce the number of sub-states to reduce the second object OB in size, thereby enabling the display region of the display 120 to display all the second objects OB at once.

(1-3) In a case where the number of first objects OA included in the first content C1 is too large to be displayed all at once in the display region of the display 120, the display control unit 133 may cause the display 120 to display the first content C1 in a scrollable manner. The same applies to the second content C2.

(1-4) While in the example of FIG. 6, the first object OA indicates a main state using a character string such as “ON” and “OFF” or the like, the present disclosure is not limited thereto, and the main state may be indicated by a level of luminance. In this case, for the apparatus 200 having the main state being “ON”, the display control unit 133 only needs to display the first object OA in a first luminance, and for the apparatus 200 having the main state being “OFF”, the display control unit 133 only needs to display the first object OA in a second luminance lower than the first luminance. Alternatively, the display control unit 133 may display the main state in a shade of color instead of the level of luminance. For example, for the apparatus 200 having the main state being “ON”, the display control unit 133 may display the first object OA in a first color with a first concentration and for the apparatus 200 having the main state being “OFF”, the display control unit 133 may display the first object OA in a second color with a second concentration lower than the first concentration. This enables even a user having poor eyesight who is away from the display device 100 to easily recognize a main state of each apparatus 200.

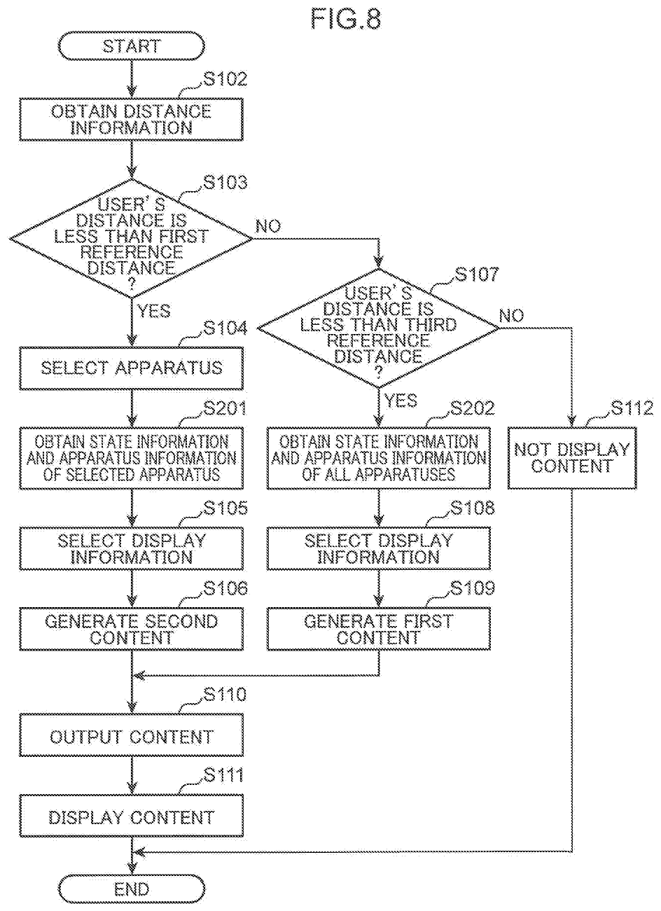

(1-5) While in the present embodiment, the flow shown in FIG. 7 is adopted as operation of the display device 100, the present disclosure is not limited thereto, and the flow shown in FIG. 8 may be adopted. FIG. 8 is a flow chart showing operation of another example of the display device 100 according to the first embodiment of the present disclosure. In FIG. 8, the same step numbers are applied to the same processing as in FIG. 7 to omit description thereof.

While in the flow of FIG. 7, after the state information and the apparatus information of all the apparatuses 200 are once obtained in S100 and S101, the display information is selected in S105, in the flow of FIG. 8, the state information and the apparatus information are obtained after the flow branches in S103.

Specifically, in S201 subsequent to S104, the information obtaining unit 132 obtains the state information of the apparatus 200 selected in S104 from the apparatus 200 via the communication unit 150, and also obtains the apparatus information from the apparatus information storage unit 141. Then, by processing in S105 and following steps, a second content C2 is generated and displayed in the display 120.

On the other hand, in S202 subsequent to YES in S107, the information obtaining unit 132 obtains the state information of all the apparatuses 200 via the communication unit 150, and also obtains the apparatus information from the apparatus information storage unit 141 similarly to S100 and S101 in FIG. 7. Then, hereinafter, the processing ends without generation of the first content C1 or without displaying of contents in the same manner as in FIG. 7.

In this modification, in a case where a user's distance to the display device 100 is less than the first reference distance (YES in S103), state information is obtained only of the apparatus 200 selected in S104 (S201). Thus, communication traffic in the communication network NT in this case can be suppressed.

(1-6) While the first content C1 indicates the number J of first objects OA indicative of states of all the number J of apparatuses 200, all the number J of first objects OA indicative of states of all the number J of apparatuses 200 may not necessarily be displayed. For example, for such an apparatus being constantly energized and apparently in operation as a refrigerator, the first object OA may not be included in the first content C1.

(1-7) The constituent elements of the processor 130 shown in FIG. 1 may be mounted on a cloud server. In this case, the display device 100 only needs to display the first content C1 and the second content C2 transmitted from the cloud server in the display 120.

(1-8) While in FIG. 1, the distance information obtaining unit 131 obtains distance information from the distance sensor 110, the present disclosure is not limited thereto, and the distance information obtaining unit may obtain distance information from, e.g., an external device provided outside the display device 100 and having a function of detecting a user's distance. Here, it is possible to adopt, as an external device, e.g., a device which calculates a distance between a user and the display device 100 using a distance sensor disposed on a ceiling or the like to take bird's-eye view of a room and transmits the calculated distance to the display device 100 at a predetermined frame rate. Alternatively, the external device may be a device which calculates not a distance between a user and the display device 100 but a distance between the user and itself using a distance sensor. In this case, the distance information obtaining unit 131 only needs to calculate a distance between the user and the display device 100 by using position information of a predetermined external device and of the display device 100 and distance information indicative of distances of the external device and the user which are obtained from the external device.

### Second Embodiment

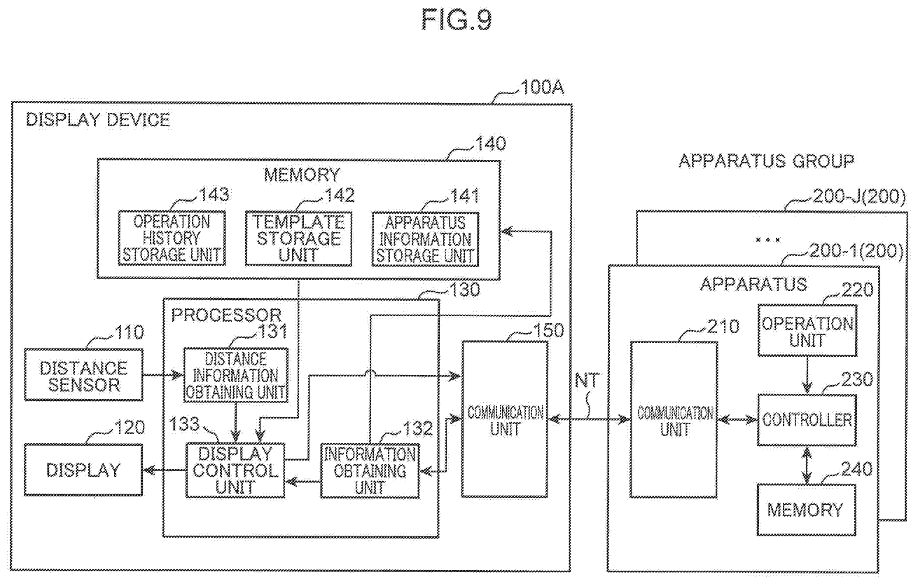

In a second embodiment, an apparatus 200 which satisfies a predetermined condition is selected based on an operation history of the apparatus 200. FIG. 9 is a block diagram showing a configuration of a display system including a display device 100A according to the second embodiment of the present disclosure. In the present embodiment, the same constituent elements as those of the first embodiment are given the same reference signs to omit description thereof. Additionally, for operation of the display device 100A in the present embodiment, the flow shown in FIG. 7 or FIG. 8 is adopted.

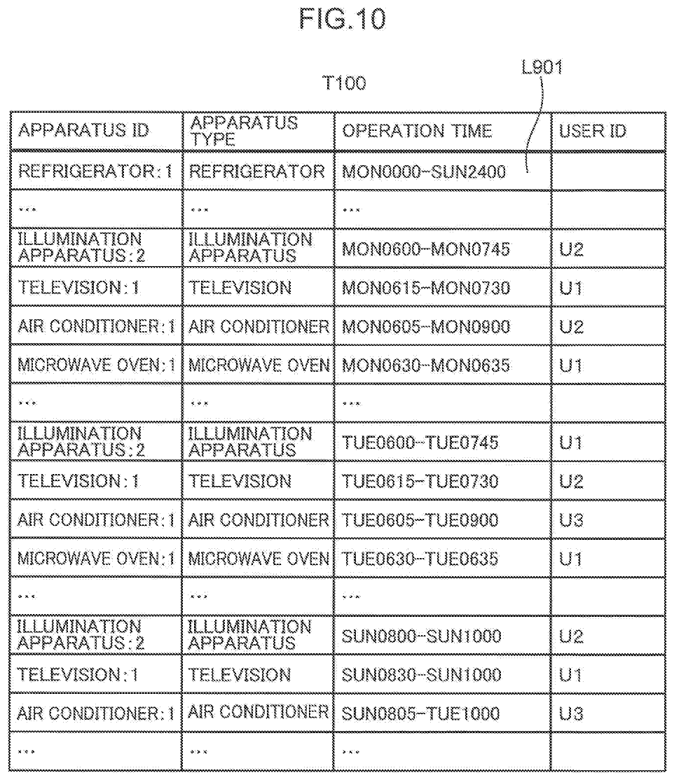

FIG. 9 is different from FIG. 1 in that an operation history storage unit 143 is further provided in the memory 140. The operation history storage unit 143 stores operation histories of the number J of apparatuses 200. FIG. 10 is a diagram showing a configuration of an operation history table T100 constituting an operation history of the apparatus 200.

For each of the number J of apparatuses 200, the operation history table T100 stores a time zone in which the apparatus was operated and in a case where the apparatus was operated by user's operation, stores a user who operated the apparatus on a fixed time period basis. Although in the example of FIG. 10, the operation history table T100 is created on a week basis, this is one example, and the operation history table T100 may be created on a two-week basis, on a month basis, and the like.

In the operation history table T100, one record is created for each one operation of each apparatus 200. Here, one operation represents operation from turn-on of the power supply until turn-off of the same. Also in the operation history table T100, records are sequentially stored in time series from the top. One record in the operation history table T100 represents one operation history.

The operation history table T100 stores “apparatus ID”, “apparatus type”, “operation time”, and “user ID” so as to be associated with each other. “Apparatus ID” and “apparatus type” are the same as those described with reference to FIG. 2. “Operation time” represents operation time for one operation of the apparatus 200.

For example, because the apparatus 200 in the third line and with the apparatus ID “illumination apparatus: 2” is turned on at 6:00 on Monday and turned off at 7:45 on Monday, a record of operation time “MON0600-MON0745” is generated. Because the apparatus 200 is also turned on at 6:00 on Tuesday and turned off at 7:45 on Tuesday, a record of operation time “TUE0600-TUE0745” is newly generated.

“User ID” indicates an identifier of a user who has operated the apparatus 200. For example, because the apparatus 200 in the third line and with the apparatus ID “illumination apparatus: 2” is turned on by operation by a user with a user ID “U2”, “U2” is listed as “user ID”. For example, if the apparatus 200 is provided with a function of specifying a user who has operated the apparatus, for specifying such a user, the display device 100 only needs to obtain a user ID of a user who has operated the apparatus 200 from the apparatus 200. If a device is installed which monitors user's operation of the apparatus 200 by using a camera disposed on a ceiling of a room or the like to take bird's-eye view of the room, the display device 100 only needs to obtain a user ID of a user who has operated the apparatus 200 from the installed device. If the display device 100 itself is provided with a function of monitoring user's operation of the apparatus 200 by using a camera, the display device 100 only needs to obtain a user ID of a user who has operated the apparatus 200 by using the function. Since “user ID” is used in a fourth embodiment to be described later, it is not an essential constituent element in the present embodiment.

The operation history table T100 is generated by communication of the information obtaining unit 132 with the apparatus 200 by using the communication unit 150. Specifically, the information obtaining unit 132 only needs to generate the operation history table T100 by determining whether or not each apparatus 200 is in operation, using state information periodically or spontaneously transmitted from the apparatus 200. In this case, if the apparatus 200 is provided with a function of specifying a user who has operated the apparatus, a user ID of a user who has operated the apparatus only needs to be included in state information transmitted from the apparatus 200. Then, the information obtaining unit 132 generates the operation history table T100 by totaling state information on a week basis, and causes the operation history storage unit 143 to store the operation history table T100. The display control unit 133 only needs to conduct processing of selecting the apparatus 200 by using the operation history table T100 generated in the latest week from among the operation history tables T100 thus generated on a week basis.

The display control unit 133 refers to the operation history table T100 to specify the apparatus 200 operated in a predetermined time zone including the current time and select the specified apparatus 200 as an apparatus 200 satisfying a predetermined condition. Here, the predetermined time zone represents each time zone obtained by dividing one day by a fixed time interval. In a case where, for example, one day is divided by 30 minutes, a time zone such as a time zone of 7:00 to 7:29, a time zone of 7:30 to 7:59, and the like correspond to a predetermined time zone.

For example, assuming that the current time is 8:00, 8:00 to 8:29 corresponds to a predetermined time zone. In this case, since apparatuses 200 which have operated in this time zone in the operation history table T100 are a refrigerator having an apparatus ID “refrigerator: 1”, an air conditioner having the apparatus ID “air conditioner: 1”, and an illumination apparatus having the apparatus ID “illumination apparatus: 2”, these apparatuses 200 are selected as apparatuses 200 satisfying a predetermined condition.

Thus, the display control unit 133 selects an apparatus 200 which has operated at least once in a predetermined time zone including the current time in the operation history table T100 as an apparatus 200 satisfying a predetermined condition.

However, this is one example, and the display control unit 133 may select an apparatus 200 which has operated at least a number n (n is an integer of two or more) of times in a predetermined time zone including the current time in the operation history table T100 as an apparatus 200 satisfying a predetermined condition.

For example, it is assumed that n is three times and the current time is 8:00. In this case, since an apparatus 200 which has operated three or more times in the time zone of 8:00 to 8:29 in the operation history table T100 is an air conditioner having the apparatus ID “air conditioner: 1”, this apparatus 200 is selected an apparatus 200 satisfying a predetermined condition.

Further, when today is a weekday, the display control unit 133 may refer only to an operation history of a weekday in the operation history table T100 to select an apparatus 200 satisfying a predetermined condition and when today is a holiday, the display control unit 133 may refer only to an operation history of a holiday in the operation history table T100 to select an apparatus 200 satisfying a predetermined condition.

Further, the display control unit 133 may select the apparatus 200 by using a method combining the method of the first embodiment and the method of the second embodiment. Specifically, the display control unit 133 may select an apparatus 200 which has operated in a predetermined time zone including the current time from among the apparatuses 200 arranged in the same room as the display device 100 or arranged at a position at a distance of less than the second reference distance as an apparatus 200 satisfying a predetermined condition.

The display control unit 133 may further specify an apparatus 200 constantly energized in the operation history table T100 to select the specified apparatus 200 as an apparatus 200 not satisfying a predetermined condition. Additionally, it can be found that the refrigerator with the apparatus ID “refrigerator: 1” shown in line L901 in FIG. 10 is an apparatus which has been continuously in operation for one week and been constantly energized from the “operation history”. Since an operation state of thus constantly energized apparatus 200 is obvious for a user, the state may not be indicated in the second content C2. Therefore, adopting such a mode prevents a state of the apparatus 200 which is not required to be indicated for a user from being included in the second content C2.

Thus, according to the second embodiment, in a case where a user's distance to the display device 100 becomes less than the first reference distance, an apparatus 200 which has operated in a predetermined time zone including the current time is selected. Thus, it is possible to display the second object OB of the apparatus 200 which is highly likely to be operated by a user at present.

### Third Embodiment

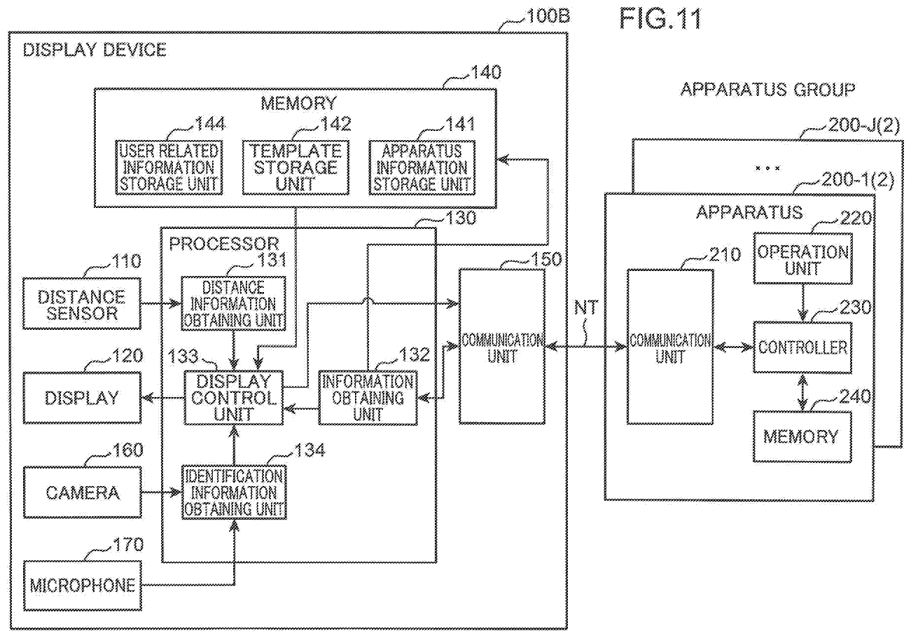

In a third embodiment, a condition in accordance with identification information of a user is adopted as a predetermined condition to select the apparatus 200. FIG. 11 is a block diagram showing a configuration of a display system including a display device 100B according to the third embodiment of the present disclosure. In the present embodiment, the same constituent elements as those of the first and second embodiments are given the same reference signs to omit description thereof.

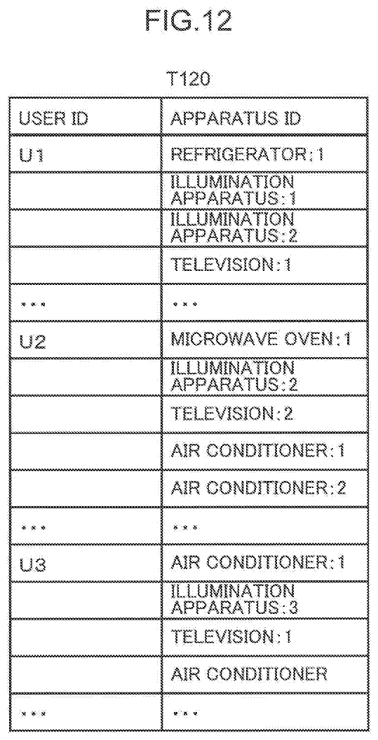

FIG. 11 is different from FIG. 1 in that a camera 160 and a microphone 170 are further provided in the display device 100B, an identification information obtaining unit 134 is further provided in the processor 130, and a user related information storage unit 144 is further provided in the memory 140. The user related information storage unit 144 stores user related information indicative of one or more users and one or more apparatuses 200 associated with each user in advance. FIG. 12 is a diagram showing a configuration of a user related information table T120 constituting the user related information.

The user related information table T120 is a table in which the apparatus 200 associated with each user in advance is stored, in which a “user ID” and an “apparatus ID” are stored so as to be associated with each other. The “user ID” is an identifier of a user and the “apparatus ID” is an identifier of an apparatus 200.

In the example in the FIG. 12, the apparatuses 200 having the apparatus ID “refrigerator: 1”, the apparatus ID “illumination apparatus: 1”, the apparatus ID “illumination apparatus: 2”, the apparatus ID “television: 1”, and the like are associated with a user having a user ID “U1”. Also, the apparatuses 200 are similarly associated with users having other user IDs “U2” and “U3”.

In the user related information table T120, the apparatus 200 whose state is highly likely to be checked or which is highly likely to be operated by each user is listed in advance. The user related information table T120 is created in advance based on information input by a user.

Reference is made again to FIG. 11. The camera 160 is attached to, for example, a surface of the display device 100B and captures an image of the surroundings of the display device 100B at a predetermined frame rate. The microphone 170 is attached to, for example, the surface of the display device 100B and collects voice in the surroundings of the display device 100B and converts the same into a voice signal.

The identification information obtaining unit 134 identifies a user around the display device 100B by using the image captured by the camera 160 or the voice signal collected by the microphone 170, thereby obtaining identification information of the user. As identification information of a user, for example, a user ID can be adopted.

The identification information obtaining unit 134 extracts a feature amount of a user's face included in the image captured by the camera 160. Then, the identification information obtaining unit 134 only needs to specify a user around the display device 100B by collating the extracted feature amount with a user table (not shown) in which a feature amount of a face of each user living in a building and a user ID are stored in advance. Here, in a case where the image captured by the camera 160 includes a plurality of users, the identification information obtaining unit 134 only needs to extract a feature amount of a face of a user displayed largest in the image.

Alternatively, the identification information obtaining unit 134 extracts a voice print from the voice signal obtained by the microphone 170. Then, the identification information obtaining unit 134 only needs to specify a user around the display device 100B by collating the extracted voice print and a user table (not shown) in which a voice print of each user living in a building and a user ID are associated with each other.

The identification information obtaining unit 134 specifies a user around the display device 100B by using these methods to obtain a user ID of the user and output the same as identification information to the display control unit 133.

The display control unit 133 obtains the user related information table T120 from the user related information storage unit 144, and selects, from the user related information table T120, the apparatus 200 associated with the user ID output from the identification information obtaining unit 134 as an apparatus 200 satisfying a predetermined condition. For example, assuming that the user ID “U1” is output from the identification information obtaining unit 134, an apparatus 200 associated with the user ID “U1” in the user related information table T120 is selected as an apparatus 200 satisfying a predetermined condition.

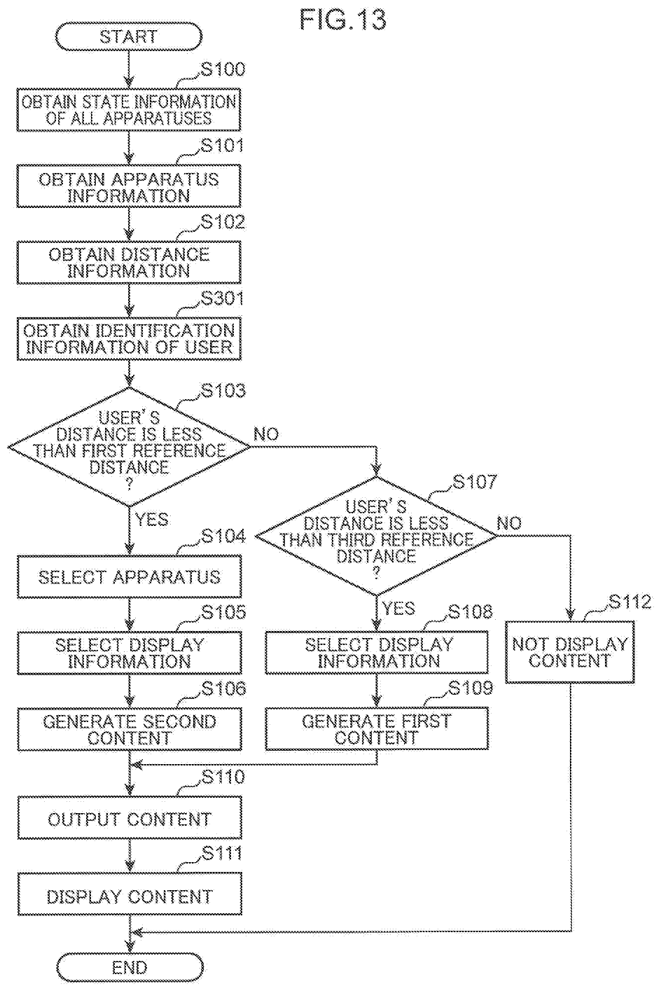

FIG. 13 is a flow chart showing operation of the display device 100B according to the third embodiment of the present disclosure. In the flow shown in FIG. 13, the same processing as that of the flow in FIG. 7 is given the same reference signs to omit description thereof.

In S301 subsequent to S102, the identification information obtaining unit 134 obtains identification information (user ID) of a user around the display device 100B by using the image captured by the camera 160 or the voice signal collected by the microphone 170.

In the selection of an apparatus in S104, the display control unit 133 selects an apparatus 200 determined in advance for the identification information (user ID) obtained in S301 from the user related information table T120 as described above. Hereinafter, the same processing as in FIG. 7 will be conducted.

As described above, according to the third embodiment, in a case where a user's distance to the display device 100B is less than or equal to the first reference distance, an apparatus 200 associated with a user around the display device 100B in advance is selected. Thus, by determining an apparatus which is highly likely to be operated or whose state is highly likely to be checked by a user in advance, the user is allowed to select an apparatus 200 which is highly likely to be operated or whose state is highly likely to be checked by a user and include the state of the apparatus 200 in the selected second content C2. Also, according to the third embodiment, while all the users are selection targets for, e.g., an air conditioner in a living room, and a second object OB is displayed when anyone approaches the display device 100B, another mode can be realized in which a second object OB is displayed for an air conditioner in a bed room only when a user of the bed room approaches the display device 100B.

The third embodiment can adopt the following modifications.

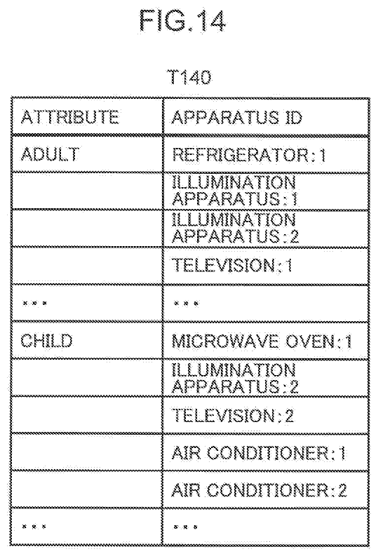

(3-1) FIG. 14 is a diagram showing a configuration of a user related information table T140 according to a modification of the third embodiment of the present disclosure. In the user related information table T140, an apparatus 200 is associated with a corresponding “attribute” of a user instead of a “user ID”. Specifically, the user related information table T140 stores “attribute” and “apparatus ID” so as to be associated with each other. “Attribute” represents an attribute of a user such as adult, child, female, and male.

Here, in the user related information table T140, an apparatus 200 whose state is highly likely to be checked or which is highly likely to be operated by a user having a relevant attribute is stored in advance. Here, the user related information table T140 is created in advance based on information input by a user. For example, with respect to an apparatus 200 which is not to be operated by a child, the user related information table T140 is set so that such an apparatus will not be associated with a child.

In this case, the identification information obtaining unit 134 specifies an attribute of a user by using an image captured by the camera 160 or a voice signal obtained by the microphone 170. Specifically, the identification information obtaining unit 134 extracts a feature amount of the user from the image captured by the camera 160 and analyzes the feature amount to determine an attribute of the user, and outputs the determined attribute to the display control unit 133 as identification information. Alternatively, by analyzing the voice signal obtained by the microphone 170, the identification information obtaining unit 134 determines an attribute of the user and outputs the determined attribute to the display control unit 133 as identification information.

The display control unit 133 specifies, from the user related information table T140, an apparatus 200 associated with the attribute output from the identification information obtaining unit 134 and selects the apparatus 200 as an apparatus 200 satisfying a predetermined condition.

According to the modification, it is possible to select an apparatus 200 which is highly likely to be operated or whose state is highly likely to be checked according to an attribute of a user to generate the second content C2.

(3-2) The display control unit 133 may select an apparatus 200 by using a method combining the method shown in the third embodiment or the method shown in the modification (3-1) of the third embodiment, and the methods shown in the first embodiment and the second embodiment. Specifically, first, the display control unit 133 selects an apparatus 200 which has operated in a predetermined time zone including the current time from among the apparatuses 200 arranged in the same room as in the display device 100 or arranged at a position at a distance of less than the second reference distance. Next, the display control unit 133 only needs to further select, among the selected apparatuses 200, an apparatus 200 associated with a user ID of a relevant user in the user related information table T120 or an apparatus 200 associated with an attribute of the relevant user in the user related information table T140 as an apparatus 200 satisfying a predetermined condition.

### Fourth Embodiment

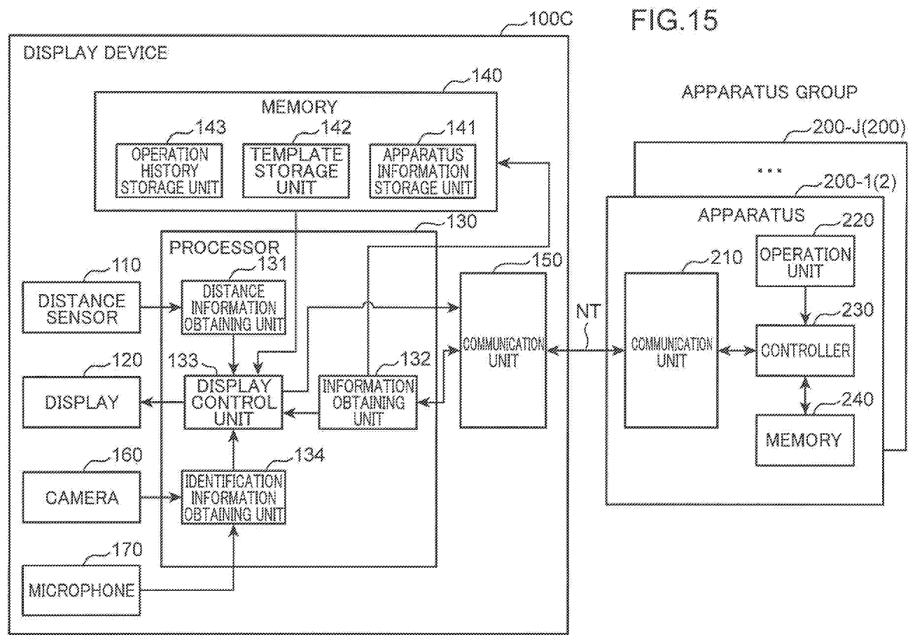

In a fourth embodiment, an apparatus 200 with a high frequency of use by a user is selected as an apparatus 200 satisfying a predetermined condition. FIG. 15 is a block diagram showing a configuration of a display system including a display device 100C according to the fourth embodiment of the present disclosure. In the present embodiment, the same constituent elements as those of the first to third embodiments are given the same reference signs to omit description thereof. For operation of the display device 100C in the present embodiment, the flow shown in FIG. 13 is adopted.

The display device 100C shown in FIG. 15 is realized by adding the camera 160 and the microphone 170 to the display device 100A shown in FIG. 9 and adding the identification information obtaining unit 134 to the processor 130.

By using an user ID output by the identification information obtaining unit 134 as an identification result of a user and the operation history table T100 shown in FIG. 10, the display control unit 133 selects, as an apparatus 200 satisfying a predetermined condition, an apparatus 200 with a frequency of use of the apparatus 200 by a relevant user of greater than or equal to a reference frequency determined in advance.

For example, assuming that the user ID “U1” is output from the identification information obtaining unit 134, the display control unit 133 extracts, from the operation history table T100, an operation history with which the user ID “U1” is associated. Then, the display control unit 133 classifies the extracted operation history for each apparatus 200 to calculate the number of operation histories for each apparatus 200 as a frequency of operation of each apparatus 200. Then, the display control unit 133 selects, as an apparatus 200 satisfying a predetermined condition, an apparatus 200 with a frequency of operation calculated for each apparatus 200 of greater than or equal to the reference frequency.

In this manner, when a user approaches the display device 100C, the apparatus 200 is selected and the second content C2 including the second object OB of the apparatus 200 is displayed in the display 120.

As described above, in the fourth embodiment, in a case where a user's distance to the display device 100C is less than or equal to the first reference distance, an apparatus having a high frequency of use by a user is selected. Thus, an apparatus which is highly likely to be operated or whose state is highly likely to be checked by a user can be selected.

According to the present disclosure, bird's-eye view properties and minuteness can be ensured without imposing burdensome operation on a user. Thus, the present disclosure is useful, for example, as a display device buried in an inside wall of a building such as a house.

This application is based on Japanese Patent application No. 2018-192622 filed in Japan Patent Office on Oct. 11, 2018, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A display method in a display device installed in a building,
the display method comprising, by a processor of the display device:
obtaining distance information acquired using a sensor, the distance information being indicative of a distance between the display device and a user;
obtaining states of a first number of apparatuses installed in the building by using a communication device;
when a distance indicated by the distance information is greater than or equal to a first reference distance, displaying, in a display, a second number of first objects each corresponding to each or a plurality of the first number of apparatuses and indicative of a state of the corresponding apparatus; and
when a distance indicated by the distance information is less than the first reference distance, selecting, a third number of apparatuses from among the first number of apparatuses according to a predetermined condition, the third number being smaller than the first number, to display, in the display, a fourth number of second objects each corresponding to each or a plurality of the third number of apparatuses and indicative of a state of the corresponding apparatus.

2. The display method according to claim 1, wherein an amount of information about the state of the apparatus indicated by the second object is larger than an amount of information about the state of the apparatus indicated by the first object.

3. The display method according to claim 1, further comprising:
obtaining apparatus information indicative of a distance of the first number of apparatuses to the display device; and
specifying the apparatus at a distance from the display device of less than a second reference distance based on the apparatus information to select the specified apparatus as the apparatus satisfying the predetermined condition.

4. The display method according to claim 1, further comprising:
obtaining operation histories of the first number of apparatuses; and
specifying the apparatus operated in a predetermined time zone including current time based on the operation histories to select the specified apparatus as the apparatus satisfying the predetermined condition.

5. The display method according to claim 1, further comprising:
obtaining apparatus information in which an installation position and a type of the installation position of each of the first number of apparatuses are associated with each other; and
specifying an apparatus having the same type of installation position as a type of installation position of the display device based on the apparatus information, to select the specified apparatus as the apparatus satisfying the predetermined condition.

6. The display method according to claim 1, further comprising:
obtaining operation histories of the first number of apparatuses; and
specifying the apparatus constantly energized based on the operation histories to select the specified apparatus as the apparatus not satisfying the predetermined condition.

7. The display method according to claim 1, further comprising:
obtaining identification information of the user based on voice or an image of the user,
wherein the predetermined condition is a condition in accordance with the identification information.

8. The display method according to claim 7, further comprising:
obtaining user related information in which the identification information of the user and one or more of the first number of apparatuses are associated with each other; and
specifying the apparatus corresponding to the user based on the identification information and the user related information to select the specified apparatus as the apparatus satisfying the predetermined condition.

9. The display method according to claim 7, further comprising:
obtaining an operation history including an operation history of the user for each of the first number of apparatuses; and
specifying an apparatus with a frequency of use by the user of greater than or equal to a reference frequency determined in advance based on the identification information and the operation history to select the specified apparatus as the apparatus satisfying the predetermined condition.

10. The display method according to claim 7, further comprising:
obtaining user related information in which an attribute of the user and one or more of the first number of apparatuses are associated with each other; and
specifying an attribute of the user from the identification information, and based on the specified attribute of the user and the user related information, specifying the apparatus corresponding to the attribute of the user to select the specified apparatus as the apparatus satisfying the predetermined condition.

11. The display method according to claim 1, wherein in a case where a distance indicated by the distance information is greater than or equal to a third reference distance which is larger than the first reference distance, the first object is not displayed.

12. The display method according to claim 1, wherein the first object is displayed in a color corresponding to an operation state.

13. A display device installed in a building, the display device comprising:
a communication device;
a processor; and
a display,
wherein the processor
obtains distance information acquired using a sensor, the distance information being indicative of a distance between the display device and a user,
obtains states of a first number of apparatuses installed in the building by using the communication device,
when a distance indicated by the distance information is greater than or equal to a first reference distance, displays, in the display, a second number of first objects each corresponding to each or a plurality of the first number of apparatuses and indicative of a state of the corresponding apparatus, and
when a distance indicated by the distance information is less than the first reference distance, selects a third number of apparatuses from among the first number of apparatuses according to a predetermined condition, the third number being smaller than the first number, to display, in the display, a fourth number of second objects each corresponding to each or a plurality of the third number of apparatuses and indicative of a state of the corresponding apparatus.

14. A non-transitory computer-readable recording medium which stores a display program which causes a processor of a display device installed in a building to:
obtain distance information acquired using a sensor, the distance information being indicative of a distance between the display device and a user,
obtain states of a first number of apparatuses installed in the building by using a communication device,
when a distance indicated by the distance information is greater than or equal to a first reference distance, display, in a display, a second number of first objects each corresponding to each or a plurality of the first number of apparatuses and indicative of a state of the corresponding apparatus, and
when a distance indicated by the distance information is less than the first reference distance, select, a third number of apparatuses from among the first number of apparatuses according to a predetermined condition, the third number being smaller than the first number, to display, in the display, a fourth number of second objects each corresponding to each or a plurality of the third number of apparatuses and indicative of a state of the corresponding apparatus.
